(19) United States
(12) Patent Application Publication
(10) Pub. No.: US 2011/0295587 A1
(43) Pub. Date: Dec. 1, 2011

(54) METHODS AND SYSTEMS FOR SIMULATING A PROCESSOR

(76) Inventors: Lieven EECKHOUT, Evergem (BE); Stijn EYERMAN, Evergem (BE); Davy GENBRUGGE, Evergem (BE)

(21) Appl. No.: 12/791,306

(22) Filed: Jun. 1, 2010

(51) Int. Cl. G06F 17/50

(52) U.S. Cl. 703/21

(57) ABSTRACT

A method is described for simulating a set of instructions to be executed on a processor. The method comprises performing a functional simulation of the processor over a number of simulation cycles. Performing the functional simulation of the processor thereby may comprise using an analytical model comprising a timing estimator and estimating during the functional simulation timing information of the processor.

### FIELD OF THE INVENTION

The invention relates to the field of processor architecture. More particularly, the present invention relates to methods and systems for simulating processors and their operation.

### BACKGROUND OF THE INVENTION

Architectural simulation is an invaluable tool in a computer architect's toolbox for evaluating design trade-offs and novel research ideas. However, architectural simulation faces two major challenges. First, it is extremely time consuming: simulating an industry-standard benchmark for a single microprocessor design point easily takes a couple days or weeks to run to completion, even on today's fastest machines and simulators. Culling a large design space through architectural simulation of complete benchmark executions thus simply is infeasible. While this is already true for single-core processor simulation, the current trend towards multi-core processors only exacerbates the problem. As the number of cores on a multi-core processor increases, simulation speed has become a major concern in computer architecture research and development. Second, developing an architectural simulator is tedious, costly and very time consuming.

Architects in industry and academia rely heavily on cycle-level (and in some cases true cycle-accurate) simulators. The limitation of cycle-level simulation is that it is very time-consuming. Industry single-core simulators typically run at a speed of 1 KHz to 10 KHz; academic simulators typically run at tens to hundreds of KIPS (kilo instructions per second). Multi-core processor simulators exacerbate the problem even further because they have to simulate multiple cores, and have to model inter-core communication (e.g., cache coherence traffic) as well as resource contention in shared resources. Besides concerns regarding the development effort and time of detailed cycle-level simulators, this level of detail is not always appropriate, nor is it called for. For example, early in the design process when the design space is being explored and the high-level microarchitecture is being defined, too much detail only gets in the way. Or, when studying trade-offs in the memory hierarchy, cache coherence protocol or interconnection network of a multi-core processor, cycle-accurate core-level simulation may not be needed.

Researchers and computer designers are well aware of the multi-core simulation problem and have been proposing various fast simulation methodologies, such as simplifying assumptions when simulating large multi-core and multiprocessor systems, sampled simulation, statistical simulation, analytical simulation and hardware-accelerated simulation using FPGAs.

The solution of simplifying assumptions may for example include the assumption that all cores execute one instruction per cycle, i.e., the non-memory IPC is set to one. The latter nevertheless results in timing information that is not sufficiently accurate.

The idea of sampled simulation is to simulate a number of sampling units rather than the entire dynamic instruction stream. The sampling units can for example be selected either randomly, periodically or based on phase analysis. A number of papers have been working on sampled simulation of multi-threaded and multi-core processors. In ISPASS 2004 pages 45 to 56, Van Biesbrouck et al. propose a co-phase matrix for speeding up sampled simultaneous multithreading (SMT) processor simulation running multi-program workloads. In ISPASS 2005 pages 89 to 99, Ekman and Stenström make the observation that fewer sampling units need to be taken to estimate overall performance for larger multi-processor systems than for smaller multi-processor systems in case one is interested in aggregate performance only. Similar conclusions were found for throughput server workloads (Wenisch et al., IEEE Micro, Vol 26, No 4, 2006). Estimating microarchitecture state at the beginning of sampling unit is another challenging issue for multiprocessor sampled simulation. One suggested solution is the Memory Timestamp Record (MTR) to store microarchitecture state (cache and directory state) at the beginning of a sampling unit as a checkpoint (Barr et al. ISPASS 2005 pages 66 to 77).

FPGA-accelerated simulation speeds up simulation by mapping timing models onto field-programmable gate-arrays (FPGAs). The timing models in FPGA-accelerated simulators are cycle-accurate, and the simulation speedup comes from exploiting fine-grain parallelism in the FPGA, see Chiou et al. in MICRO 2007 pages 249 to 261, and Pellauer et al. in ISPASS 2008 pages 1 to 8.

Statistical performance modeling has a gained a lot of interest over the past few years, see Eeckhout et al. in IEEE Micro, Vol 23, No 5, 2003. Statistical simulation speeds up architectural simulation by providing short-running synthetic traces or benchmarks that are representative for long-running benchmarks. This is done by profiling the execution of the original benchmark and capturing the key execution characteristics in the form of a statistical profile. A synthetic trace or benchmark is then generated from this statistical profile. By construction, the synthetic clone exhibits similar execution characteristics as the original benchmark. The statistical simulation paradigm was also applied to multithreaded programs running on shared-memory multiprocessor (SMP) systems. To do so, statistical simulation was extended to model synchronization and accesses to shared memory. The key benefit of statistical simulation is that the synthetic clone's dynamic instruction count is several orders of magnitude smaller than is the case for the original benchmark, which leads to dramatic reductions in simulation time.

Although these methodologies increase simulation speed and have their place in the architect's toolbox, they model the processor at a high level of detail which impacts development time and evaluation time, which may not be needed for many practical research and development studies.

Analytical performance modeling is a modeling approach at the other end of the spectrum. There are basically three approaches to analytical performance modeling: mechanistic modeling, empirical modeling and hybrid mechanistic/empirical modeling. Mechanistic modeling constructs a model based on the mechanics of the target processor, i.e., white-box modeling, see for example Eyerman et al. ACM TOCS, Vol 27, No 2, 2009. Mechanistic modeling involves running a specialized functional simulation to collect metrics regarding the number of instructions executed, the instruction mix, cache miss rates, branch misprediction rates, etc. An offline analytical model then predicts performance using these metrics. While this approach of offline performance prediction works well for single-core processor performance estimation, it does not allow for modeling timing-dependent behavior in multiprocessors, including multicore processors (e.g., cache coherence traffic, synchronization, shared resource contention). Empirical modeling learns a performance model through training and does not assume specific knowledge about the target processor, i.e., black-box modeling. Models based on neural networks (Ipek et al., ASPLOS 2006 pages 195 to 206) and regression modeling (Lee and Brooks, ASPLOS 2006 pages 185 to 194) are also known. Regression modeling also was used for predicting multiprocessor performance running multi-program workloads. Hybrid mechanistic/empirical modeling proposes a mechanistic performance formula in which the parameters are derived through empirical modeling. Both empirical modeling and hybrid mechanistic/empirical modeling involve running a fair amount of detailed simulations to learn the model.

### SUMMARY OF THE INVENTION

It is an object of embodiments of the present invention to provide good methods and systems for simulating a processor. It is an advantage of embodiments according to the present invention that accurate timing information can be provided for the simulated processor, while still obtaining an efficient simulation.

It is an advantage of embodiments according to the present invention that an architectural simulator can be provided that can be relatively easily developed. It is an advantage of embodiments according to the present invention that an architectural simulator can be provided that has relatively short evaluation times. The latter is especially advantageous for multi-core processors.

It is an advantage of embodiments according to the present invention that, compared to prior art, the level of abstraction of the architectural simulation has been raised, while still providing relevant timing information.

It is an advantage of embodiments according to the present invention that the simulator can be easily implemented as it is based on a mechanistic analytical model that incurs a relatively limited number of lines of code, e.g., less than 5000 lines of code, more advantageously less than 2000 lines of code, e.g., about 1000 lines of code. By way of comparison, a detailed cycle-level out-of-order processor core model in the University of Michigan's M5 simulator incurs about 28000 lines of code.

It is an advantage of embodiments according to the present invention that simulation according to an embodiment of the present invention, also referred to as interval simulation, can be a useful complement offering high simulation speed and short simulator development time at slightly less accuracy than detailed cycle-level simulation.

It is an advantage of embodiments according to the present invention that simulation according to an embodiment of the present invention can be envisioned as a fast simulation technique to quickly explore the design space of multi-core processor architectures and make high-level microarchitecture and system-level trade-offs, e.g., at early stages of the design, while performing thereafter detailed cycle-accurate simulation to explore a region of interest.

It is an advantage of embodiments according to the present invention that the simulator according is widely applicable.

It is an advantage of embodiments according to the present invention that the simulator can be easily combined with existing simulation speedup approaches such as sampled simulation and FPGA-accelerated simulation.

The above objective is accomplished by a method and device according to the present invention.

The present invention relates to a method for simulating a set of instructions to be executed on a processor, the method comprising performing a functional simulation of the processor over a number of simulation cycles, wherein performing the functional simulation of the processor comprises using an analytical model comprising a timing estimator and estimating during the functional simulation timing information of the processor. It is an advantage of embodiments according to the present invention that an efficient simulation method is obtained while still providing timing information.

Using an analytical model may comprise using a mechanistic analytical model comprising a timing estimator.

Wherein estimating timing information may comprise deriving a number of instructions performed during a cycle. The number of instructions may be an integer number or a non-integer number. It is an advantage of embodiments according to the present invention that an accurate estimation can be obtained.

Estimating timing information may comprise deriving instantaneous timing information. It is an advantage of embodiments according to the present invention that no use is made of average timing information, as this often results in inaccuracy. Performing the functional simulation may comprise simulating occurrences of miss events and dividing the processing time for the processor in a plurality of intervals based on the simulated miss events.

Performing the functional simulation may comprise estimating timing for at least one of the obtained plurality of intervals, the estimate being based on the simulated miss events. It is an advantage of embodiments according to the present invention that accurate timing information is obtained, allowing realistic estimation of the processing time for the processor, while avoiding the need of a cycle by cycle simulation.

Estimating timing may comprise determining a timing estimate being based on the simulated miss event terminating the interval under consideration.

The functional simulator may be adapted for first generating a dynamic instruction stream which is thereafter fed into the timing simulator. It is an advantage of embodiments according to the present invention that systems with functional first simulation can be easily developed, while still obtaining good accuracy, compared to cycle-accurate simulators.

Estimating timing information may comprise estimating timing information for a multi-core processor.

The method may comprise simulating a particular core for a multi-core processor on an event-driven basis.

Estimating timing information for at least one of the obtained plurality of intervals may comprise adding a penalty to the timing estimate as function of the simulated miss event in the interval.

Adding a penalty to the timing estimate as function of the simulated miss event in the interval may comprise adding a miss latency in case of an I-cache miss or an I-TLB miss, adding a branch penalty in case of a branch misprediction or adding a penalty for emptying an old instruction window in case of serializing instructions.

Estimating timing for at least one of the obtained plurality of intervals may comprise not adding a penalty if a miss event is independent of and is hidden by a long-latency load.

The method may comprise estimating a critical path length for executing an instruction in a window of instructions, the critical path length being determined as function of a difference in characteristic time for instructions in the window, the characteristic time being determined by the execution latency, the issue time and the output dependencies for the instruction.

The method may comprise determining an effective dispatch rate for instructions in the system based on the critical path length.

The method may comprise, after said functional simulating, adjusting a processor design used for simulating the processing and performing the functional simulation using the adjusted processor design.

The present invention also relates to a simulator for simulating the processing of a set of instructions to be executed on a processor, the simulator comprising a functional simulator for performing a functional simulation of the processor over a number of simulation cycles, wherein the functional simulator is of the processor is adapted for using a analytical model comprising a timing estimator adapted for estimating during the functional simulation timing information of the processor.

The simulator may be a computer program product for, when executing on a computer, performing a simulation of the processing of a set of instructions to be executed on a processor.

The present invention also relates to a data carrier comprising a set of instructions for, when executed on a computer, performing a functional simulation of processing of a set of instructions to be executed on a processor over a number of simulation cycles, wherein performing the functional simulation of the processor comprises using an analytical model comprising a timing estimator and estimating during the functional simulation timing information of the processor.

The data carrier may be any of a CD-ROM, a DVD, a flexible disk or floppy disk, a tape, a memory chip, a processor or a computer.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1a illustrates a schematic representation of a processor and its components that can benefit from a method for simulating according to an embodiment of the present invention.

FIG. 1b and FIG. 1c illustrate two examples of miss events that may occur and that can be used in a method according to an embodiment of the present invention.

FIG. 2 illustrates a flow chart of an exemplary method for simulating the processing of a set of instructions on a processor according to an embodiment of the present invention.

FIG. 3 illustrates a schematic representation of interval analysis determined by disruptive miss elements, as can be used in a method for simulating according to an embodiment of the present invention.

FIG. 4 illustrates a schematic view of a multi-core interval simulation framework, the flow of data in the simulation windows used and a corresponding part of pseudo code for controlling such data flow, as can be used in a method for simulating according to an embodiment of the present invention.

FIG. 5 shows a high-level pseudo code for a multi-core interval simulation corresponding to an exemplary simulation method according to an embodiment of the present invention.

FIG. 6 shows a flow chart algorithm for an exemplary multi-core interval simulation method according to an embodiment of the present invention.

FIG. 7 illustrates a schematic representation of a simulator according to an embodiment of the present invention.

FIG. 8a to FIG. 8d illustrates experimental results for evaluating an exemplary interval simulation in a step-by-step manner, indicating the effective dispatch rate (a), the I-cache/TLB (b), the branch prediction (c) and the L2 cache (d) for interval simulation according to an embodiment of the present invention.

FIG. 9 illustrates experimental results for the accuracy of an exemplary interval simulation for single-threaded SPEC CPU benchmarks for interval simulation according to an embodiment of the present invention.

FIG. 10a and FIG. 10b illustrate evaluation of the accuracy of an exemplary interval simulation for multi-program SPEC CPU workloads in terms of system throughput (SPT) (a) and in terms of average normalized turnaround time (ANTT) (b) as a function of the number of cores for an interval simulation according to an embodiment of the present invention.

FIG. 11 illustrates an evaluation of the accuracy of an exemplary interval simulation for multi-threaded full-system PARSEC workloads as a function of the number of cores for interval simulation according to an embodiment of the present invention.

FIG. 12 illustrates an evaluation of interval simulation in a practical design trade-off between a dual-core processor with 4 MB L2 and external DRAM versus a quad-core processor with 3D stacked DRAM and no L2 cache memory, illustrating advantages of a simulation method according to an embodiment of the present invention.

FIG. 13 illustrates an example of simulation speedup using interval simulation compared to a detailed cycle-accurate simulation of SPEC CPU2000.

FIG. 14 illustrates an example of simulation speedup using interval simulation compared to a detailed cycle-accurate simulation of PARSEC.

FIG. 15 illustrates an example of a computing system as may be used for running a method for simulating instruction processing, according to an embodiment of the present invention.

Table 1 describes specifications of an exemplary system for simulating according to an embodiment of the present invention, the system being a 4-wide superscalar out-of-order core.

The drawings are only schematic and are non-limiting. In the drawings, the size of some of the elements may be exaggerated and not drawn on scale for illustrative purposes.

Any reference signs in the claims shall not be construed as limiting the scope.

In the different drawings, the same reference signs refer to the same or analogous elements.

### DETAILED DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention. Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein. It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments. Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination. In the description provided herein, numerous specific details are set forth. However, it is understood that embodiments of the invention may be practiced without these specific details. In other instances, well-known methods, structures and techniques have not been shown in detail in order not to obscure an understanding of this description.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

Embodiments of the present invention relate to simulation of the operation of processors, e.g., in order to optimize or improve their architecture or design. By way of illustration an exemplary processor for which a simulation according to embodiments of the present invention could be performed is first provided, introducing different standard or optional components. It is to be noticed that the processor described is only one example of a processor that could benefit from the method and system according to an embodiment of the present invention, embodiments of the present invention therefore not being limited thereto. Furthermore, some other terminology related to processing of instructions also is introduced, whereby the use of particular terminology when describing certain features or aspects of the invention should not be taken to imply that the terminology is being re-defined herein to be restricted to include any specific characteristics of the features or aspects of the invention with which that terminology is associated.

Where in embodiments according to the present invention the term “functional simulation” is used, reference is made to simulation wherein the functionality of the different components of a processor or multi-processor system are taken into account, but wherein no performance is simulated.

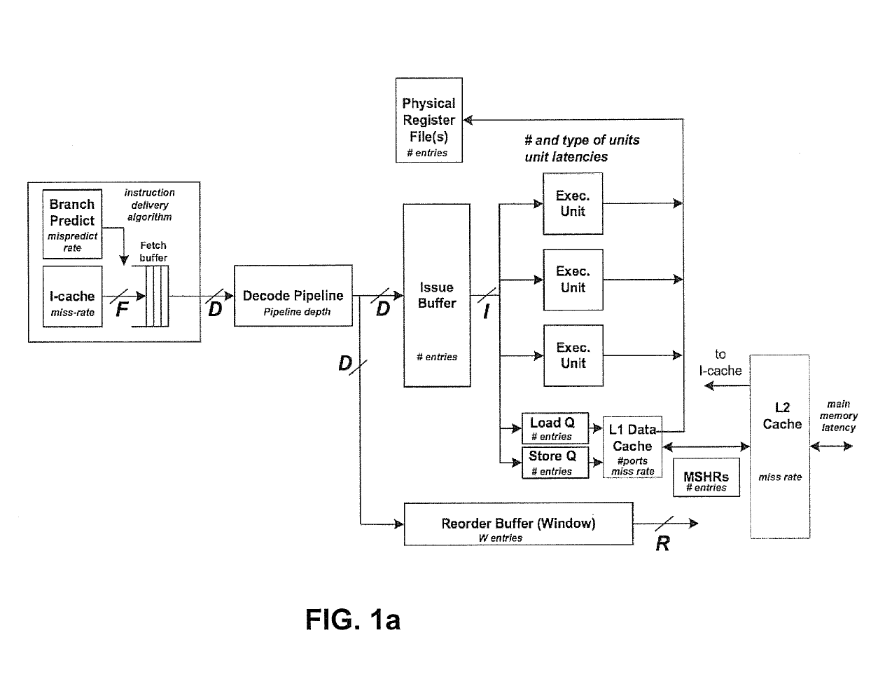

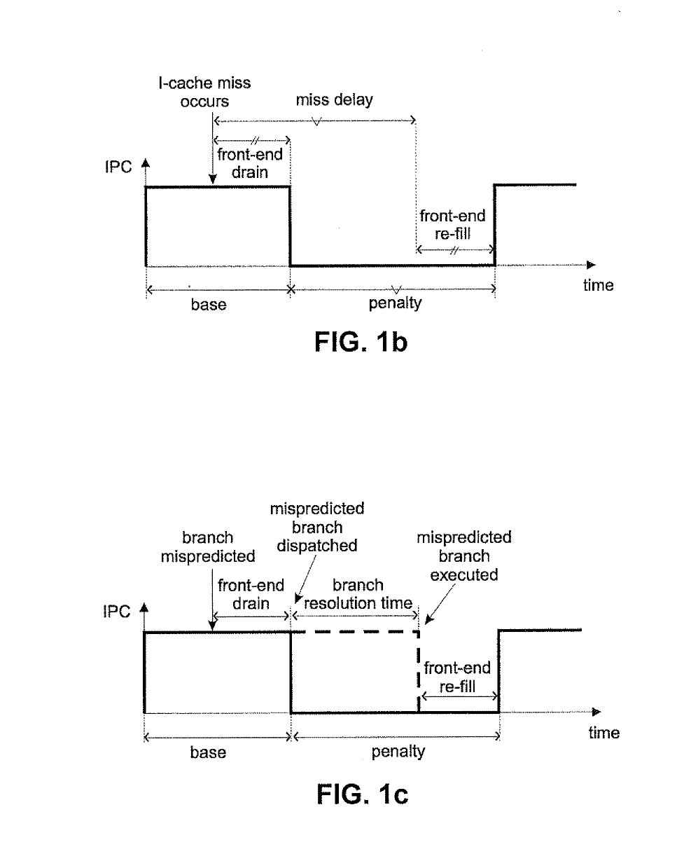

A possible processor that could benefit from embodiments of the present invention is shown in FIG. 1a. FIG. 1a illustrates a generic superscalar out-of-order processor 100. It shows a branch predictor 102, which typically may be a digital circuit that tries to guess which way a branch instruction will go in order to improve the flow of instructions in the pipeline of the processor 100. The processor comprises an I-cache 104 for caching instructions. Using an instruction delivery algorithm the instructions are provided to a Fetch buffer 106 and thereafter transferred to a decode pipeline 110 having a front-end pipeline depth. From the front-end pipeline, the instructions are routed to an issue buffer 120 for buffering instructions to be executed on the execution units, potentially out of program order, and a reorder buffer 130, for allowing instructions to be committed in program order. From the issue buffer 120, the instructions and data are distributed over at least one execution unit, also referred to as functional units 122a, 122b, 122c, . . . The output may be provided to the physical register file(s) 140. Load and store instructions are kept track of in a Load Q 150 and Store Q 152 allowing for speculative out-of-order execution of memory instructions. Data in the Load Q 150 and Store Q 152 can then be provided from and to a first level data cache memory 160, respectively; the Load Q 150 may provide results to the physical register file(s) 140. The first level data cache memory 160 is in communication with the second level cache memory 162 via MSHRs (Miss Status Handling Registers), which keep track of the outstanding memory requests. The second level cache memory, also referred to as L2 cache, typically is integrated on-chip. Optionally, there may be additional levels of cache, L3 and L4, integrated either (partially) on-chip or off-chip. Further standard and optional components of such a system also may be present (e.g., prefetch units to anticipate memory accesses and bring data in the caches pro-actively, and Translation Lookaside Buffers for caching virtual to physical address translations), as known by the person skilled in the art.

Furthermore, following definitions could apply to the terminology used in the application.

A cache miss refers to a failed attempt to read or write a piece of data in the cache, resulting in a latency of the memory access.

Where reference is made to a multi-core system, reference is made to a processor comprising a plurality of executing processing parts (processor cores) that can operate simultaneously.

Where reference is made to a cache coherency protocol, reference is made to a protocol maintaining the coherency between all the caches of the system of a shared memory machine.

Where reference is made to the memory hierarchy, reference is made to the system in computer storage distinguishing each level of memory or cache by access latency and size thus forming a hierarchy. Typically, the size and access latency is smaller for the L1 cache compared to the L2 cache; the size and access latency of the L2 cache is smaller compared to the L3 cache; etc.

In a first aspect, embodiments of the present invention relate to a method for simulating a set of instructions to be executed on a processor. Such a method for simulating comprises performing a functional simulation of the processor, by some also referred to as a system for processing or as a processing system (e.g. a processor-core, the combination of the processor-core with a set of other components allowing operation, a single-chip multicore based processor or a multi-chip multiprocessor), over a number of simulation cycles. By performing a functional simulation, efficient methods are provided for estimating timing, substantially faster than a full cycle-accurate simulation. The functional simulation of the processor thereby is based on an analytical model comprising a timing estimator for estimating during the functional simulation the timing of the processing of instructions. By using an analytical model as a timing estimator, although a functional simulation is performed, timing information regarding the timing of the processing of the set of instructions advantageously also is obtained. Simulating the timing of the processing of instructions may for example comprise simulating or estimating the number of instructions that can be performed per cycle. The analytical model may in an advantageous embodiment be a mechanistic analytical model, although embodiments of the present invention are not limited thereto and for example also a black box model such as for example an empirical model could be used.

In advantageous embodiments, performing the functional simulation as described above comprises simulating or estimating occurrences of miss events and dividing the processing time for the processor in a plurality of intervals based on the simulated miss events. This technique also may be referred to as using interval analysis. Timing information for at least one of the thus obtained intervals then may be used for obtaining the timing behavior of the processor. When using such interval simulation according to embodiments of the present invention, the mechanistic analytical model can operate at a higher level of abstraction than the core-level cycle-accurate simulation model. In other words, the analytical model estimates core-level performance by analyzing intervals, or the timing between two miss events. Such miss events may for example be branch mispredictions or TLB misses or cache misses or serializing instructions. A branch misprediction refers to an incorrectly predicted branch target or direction; a TLB miss refers to a miss in the TLB cache, i.e., the virtual to physical address mapping is not available in the TLB; a cache miss refers to a miss in the cache, i.e., the requested data is not present in the cache; a serializing instruction forces the processor to complete all instructions prior to this serializing instructions. Examples of different types of miss events also are illustrated in FIG. 1b to FIG. 1c. FIG. 1b illustrates the occurrence of a branch misprediction, FIG. 1c illustrates the occurrence of an I-cache miss, as they can occur e.g. in a system according to FIG. 1a.

These miss events divide the smooth streaming of instructions through the pipeline into so-called intervals. In one embodiment, miss events can be determined through simulation of at least one of the memory hierarchy, cache coherence protocol, interconnection network and branch predictor. Advantageously simulation of all of the memory hierarchy, cache coherence protocol, interconnection network and branch predictor can be performed. Which components are simulated may be determined based on the required accuracy and speed. In some embodiments, some miss events may be modeled instead of simulated or may even not be modeled. It is an advantage of embodiments according to the present invention that the development time for the simulator as well as the evaluation time can be significantly reduced. The latter is for example obtained by the interval simulation raising the level of abstraction in the individual cores compared to the detailed simulation, more particularly the mechanistic analytical model drives the timing simulation of the individual cores without the detailed tracking of individual instructions through the cores' pipeline stages.

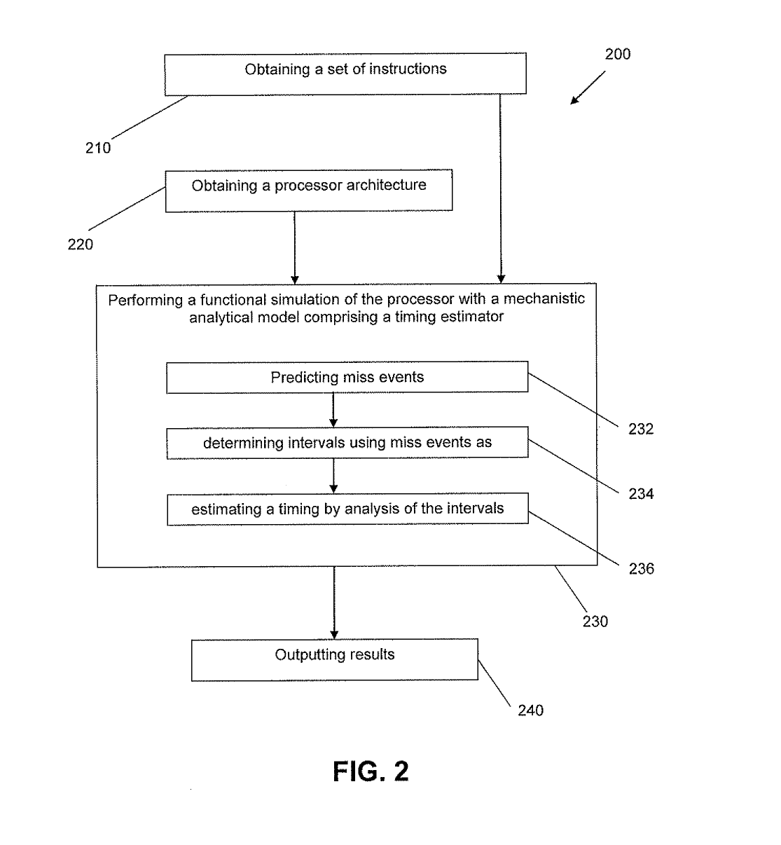

By way of illustration, embodiments of the present invention not being limited thereto, an exemplary method for simulating the processing of a set of instructions in a processor is shown in FIG. 2, indicating standard and optional steps of methods according to embodiments of the present invention.

In a first and second step, the method for simulating 200 the processing of a set of instructions in a processor comprises obtaining a set of instructions 210 and obtaining a processing architecture 220 for which the simulation is to be made. Obtaining a set of instructions 210 may for example comprise obtaining a set of instructions typically used for benchmarking simulations. Alternatively or in addition thereto, also a set of custom-made instructions could be used, e.g., if the processing quality with respect to a particular task is to be evaluated. Obtaining a processing architecture 220 may comprise obtaining the different components, their interconnectivity and their properties, such that accurate simulation can be made. The above data may already be stored in the simulation environment or may be retrieved via an input port in the simulator or simulation system.

In a following step, the method comprises performing a functional simulation 230 of the processor using an analytical model comprising a timing estimator. Such a simulation may comprise in one embodiment the steps of predicting miss events 232 such as for example branch mispredictions or TLB misses or cache misses, determining intervals 234 within the processing period using the miss events as borders and estimating 236 a timing by analysis of at least one of the intervals. The method furthermore comprises, based on the performed simulation, outputting results, such as timing information regarding the processing. Such outputting may be displayed, stored, sent, etc.

By way of illustration, further features and advantages of some embodiments of the present invention will be described with reference to particular embodiments, the present invention not being limited thereto.

According to some embodiments of the present invention, the method is implemented as a functional-first simulation approach. This means that the functional simulator generates a dynamic instruction stream, which may include user-level code or which may include user level and system-level code. The dynamic instruction stream may than be subsequently fed into the timing simulator. The timing simulator, with the interval simulation, thus is performed after the functional simulator. This implies that interval simulation does not simulate along mispredicted paths, and may lead to different thread interleavings than what may happen in real systems. It is an advantage of such embodiments that the functional and timing simulator can be easily developed while still providing good accuracy, e.g., compared to detailed cycle-level simulation.

In some embodiments an approach is applied to build a timing-directed simulator in which the timing simulator directs the functional simulator along mispredicted paths and determines thread interleavings. This can be done by having the functional simulator operate at the window head rather than at the window tail as is currently done. Timing-directed simulators can be based on checkpoint-and-rollback capability in the functional simulator and tightly couple the functional simulator with the timing simulator.

It is an advantage of embodiments according to the present invention that the simulation method can be used for single-core processors, but also for multi-core processors and multiprocessors. The cooperation between the analytical model and the miss event simulators may strongly assist in the modeling of the tight performance entanglement between co-executing threads on multi-core processors. Furthermore, simulation of a computer system is significantly simplified compared to cycle-level simulation, as can for example be seen in the length of the code implementing the model compared to the University of Michigan M5 out-of-order core simulator.

By way of illustration, further description of standard and optional features are provided with reference to particular embodiments of the present invention, embodiments not being limited thereto.

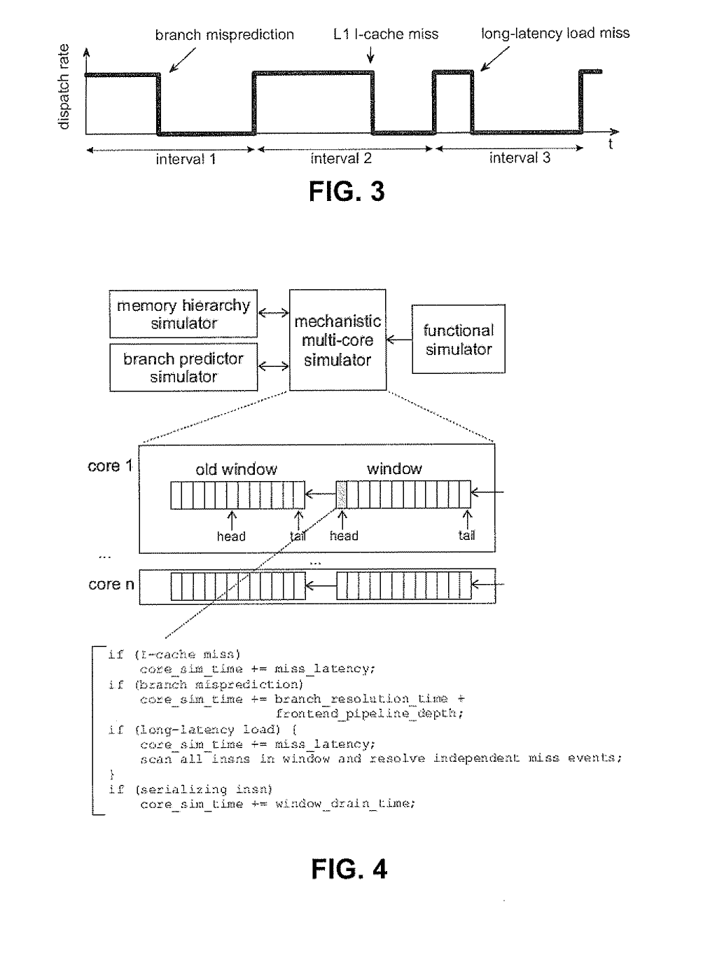

In a first particular embodiment, a method using interval analysis for a single core is described. With interval analysis, execution time is partitioned into discrete intervals by disruptive miss events such as cache misses, TLB misses, branch mispredictions and serializing instructions. The basis for the model may be an out-of order processor being designed to smoothly stream instructions through its various pipelines and functional units. Under optimal conditions (no miss events), the processor sustains a level of performance more-or-less equal to its pipeline front-end dispatch width—dispatch is being referred to as the point of entering the instructions from the front-end pipeline into the reorder buffer and issue queues. The interval behavior is illustrated in exemplary FIG. 3, which shows the number of dispatched instructions on the vertical axis versus time on the horizontal axis. By dividing execution time into intervals, one can analyze the performance behavior of the intervals individually. In particular, one can, based on the type of interval (the miss event that terminates it), describe and determine the performance penalty per miss event. By way of illustration, possible penalties that can be taken into account for different types of miss events can be seen below:
For an I-cache miss (or I-TLB miss), the penalty equals the miss delay, i.e., the time to access the next level in the memory hierarchy.
For a branch misprediction, the penalty equals the time between the mispredicted branch being dispatched and new instructions along the correct control flow path being dispatched. This penalty includes the branch resolution time plus the front-end pipeline depth.
Upon a long-latency load miss, i.e., a last-level L2 D-cache load miss or a D-TLB load miss, the processor back-end will stall because of the reorder buffer (ROB), issue queue, or rename registers getting exhausted. As a result, dispatch will stall. When the miss returns from memory, instructions at the ROB head will be committed, and new instructions will enter the ROB. The penalty for a long-latency D-cache miss thus equals the time between dispatch stalling upon a full ROB and the miss returning from memory. This penalty can be approximated by the memory access latency. In case multiple independent long-latency load misses make it into the ROB simultaneously, both will overlap their execution, thereby exposing memory-level parallelism (MLP), provided that a sufficient number of outstanding long-latency loads are supported by the hardware. The penalty of multiple overlapping long-latency loads thus equals the penalty for an isolated long-latency load. In case of dependent long-latency loads, their penalties serialize.
Chains of dependent instructions, L1 data cache misses and long-latency functional unit instructions (divide, multiply, etc.), or store instructions, may cause a resource (e.g., reorder buffer, issue queue, physical register file, write buffer, etc.) to fill up. A resource stall as a result of it may (eventually) stall dispatch. The penalty or the number of cycles where dispatch stalls due to a resource stall are attributed to the instruction at the ROB head, i.e., the instruction blocking commit and thereby stalling dispatch.

A second particular embodiment illustrates the features of the interval analysis in case of a simulation method for a multi-core processor.

A schematic representation of an exemplary simulation in case of a multi-core processor is shown in FIG. 4. A functional simulator supplies instructions to a multi-core interval simulator, which uses interval analysis for driving the timing of the individual cores. The miss events are handled by branch predictor and memory hierarchy simulators. In the present example, the branch predictor simulator models the branch predictors in the individual cores and is invoked upon the execution of a branch instruction. The branch predictor simulator returns whether or not a branch is correctly predicted by the branch predictor. The memory hierarchy simulator models the entire memory hierarchy. This includes cache coherence, private (per-core) caches and TLBs, as well as the shared last-level caches, interconnection network, off-chip bandwidth and main memory. The memory hierarchy simulator is invoked for each I-cache/TLB or D-cache/TLB access and returns the (miss) latency.

The multi-core interval simulator of the present example models the timing for the individual cores. The simulator maintains a ‘window’ of instructions for each simulated core, see FIG. 4. This window of instructions corresponds to the reorder buffer of a superscalar out-of-order processor, and is used to determine miss events that are overlapped by long-latency load misses. The functional simulator feeds instructions into this window at the window tail. Core-level progress (i.e., timing simulation) is derived by considering the instruction at the window head. By way of illustration, timing info that could be used in case of miss events could be as provided hereafter: In case of an I-cache miss, one increases the core simulated time by the miss latency. In case of a branch misprediction, one increases the core simulated time by the branch resolution time plus the front-end pipeline depth. In case of a long-latency load (i.e., a last-level cache miss or cache coherence miss), one adds the miss latency to the core simulated time, and one scans the window for independent miss events (cache/TLB misses and branch mispredictions) that are overlapped by the long-latency load—these overlaps are second-order effects. For a serializing instruction, one adds the window drain time to the simulated core time. If none of the above cases applies, one dispatches instructions at the effective dispatch rate. Having determined the impact of the instruction at the window head on the core's progress, one removes the instruction from the window and feed it into the so-called ‘old window’. The old window is used to derive the dependence chains of instructions and their impact on the branch resolution time, window drain time, and the effective dispatch rate in the absence of miss events.

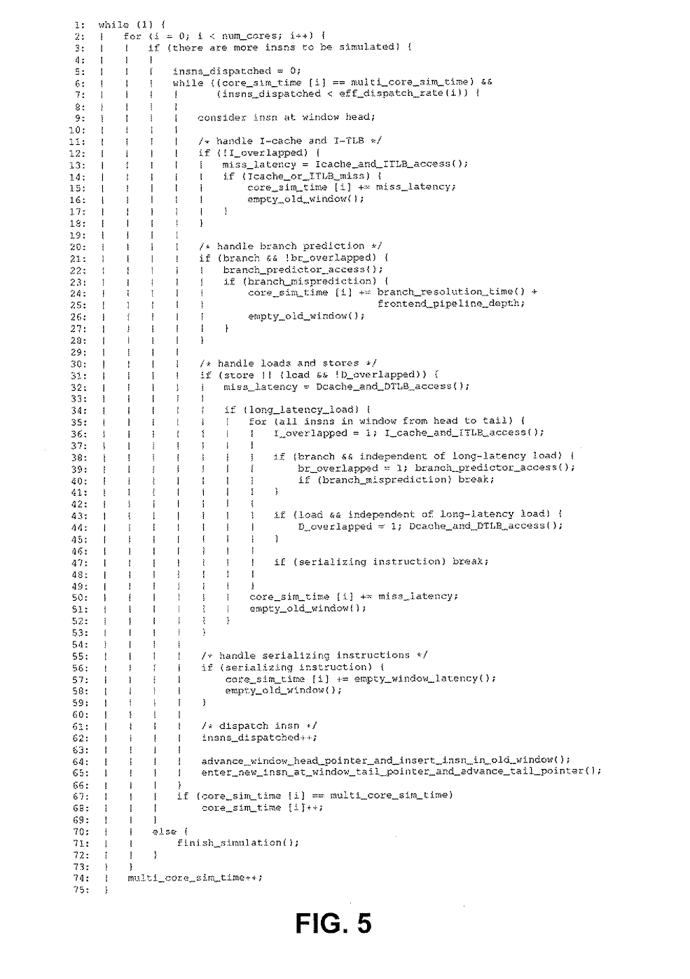

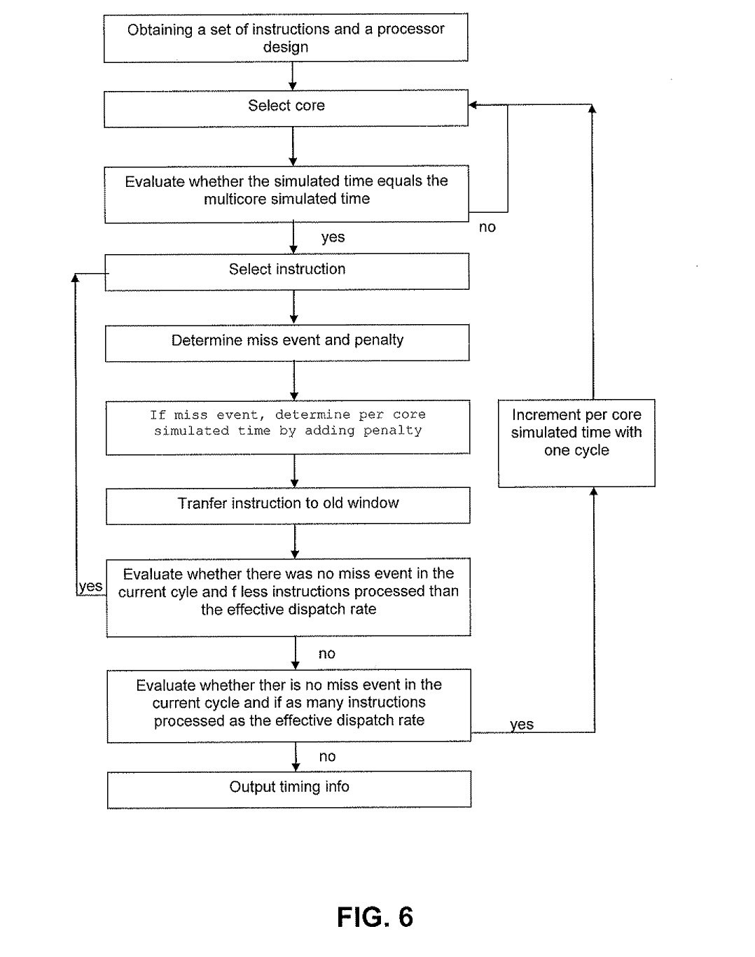

By way of illustration, an exemplary high-level pseudocode for a more detailed description of multi-core interval simulation is shown in FIG. 5. A corresponding exemplary algorithm for simulating a multi-core using interval simulation according to an embodiment of the present invention is shown in FIG. 6. In such a simulation method, the method may comprise in a first step obtaining a set of instructions and a processor design. Thereafter a core of the multi-core processor is selected. For the selected core, evaluation is made whether or not the simulated time for the core is equal to the multicore simulated time. In case the simulated time is not equal, another core is selected. If the per core simulated time is equal to the multicore simulated time, an instruction is selected and it is determined whether this instruction incurs a miss event; if so, the corresponding penalty is determined. If a miss event is present, the per core simulated time is adapted by adding a penalty. Thereafter, the instruction is transferred to the old window and depending on the number of instructions processed, i.e. whether or not the effective dispatch rate is reached, a new core or new instruction is selected. In case the number of instructions processed is smaller than the effective dispatch rate and if there is no miss event in the current cycle, a new instruction is selected. In case as many instructions are processed as the effective dispatch rate in the current cycle and if there has been no miss event, the core simulated time is incremented with one cycle and a new core is selected. In other cases the timing info is outputted. By way of example some particular steps of such a method and its possible implementation is further described below, with reference to FIG. 5.

The exemplary interval simulator iterates across all cores in the multi-core processor (line 2), and proceeds with the simulation as long as there are instructions to be simulated (line 3); if not, the simulator quits (line 71). The interval simulator simulates cycle per cycle, and keeps track of the multi-core simulated time as well as the per-core simulated time. The multi-core simulated time is incremented every cycle (line 74). The per-core simulated time is adjusted depending on the progress of the individual core, e.g., in case of a miss event, the per-core simulated time is augmented by the appropriate penalty. Only in case the per-core simulated time equals the multi-core simulated time, one needs to simulate the cycle for the given core (line 6). In case the per-core simulated time is larger than the multi-core simulated time, one does not need to simulate the cycle for the given core. This could be viewed as event-driven simulation at the core level. As long as the core has dispatched fewer instructions than the effective dispatch rate in the given cycle, one continues simulating instructions (line 7). The core-level simulation then considers the instruction at the window head (line 9) and determines its (potential) miss penalty (lines 11 to 59). One increments the number of dispatched instructions (line 62), remove the instruction from the window, and insert the instruction in the old window (lines 64). One subsequently enters a new instruction in the window at the tail pointer (line 65).

The I-cache and I-TLB (line 13) are accessed. If this instruction is an I-cache miss or an I-TLB miss, the miss latency is added to the per-core simulated time (line 15). The timing impact of a branch misprediction is fairly similar to an I-cache/TLB miss. The branch predictor (line 22) is accessed. If the branch is mispredicted (line 23), the branch penalty is added to the per-core simulated time. The branch penalty is computed as the sum of the branch resolution time and front-end pipeline depth (lines 24-25). The front-end pipeline depth is a microarchitecture parameter and is known.

For stores and non-overlapped loads (line 31), the memory hierarchy is accessed (i.e., caches, TLBs, and main memory, including the cache coherence protocol) (line 32). In case of a long-latency load, a miss penalty (i.e., the miss latency) is incurred which is added to the per-core simulated time (line 50).

Serializing instructions cause the core to drain the window prior to their execution. Therefore, upon a serializing instruction, the per-core simulated time is increased with the penalty for emptying the old instruction window (lines 56-59).

The exemplary algorithm further identifies how to deal with overlapping miss events. A long-latency load may hide latencies by other subsequent (independent) miss events—second-order effects. Therefore all instructions in the window from head to tail (line 35) upon a long-latency load are considered and four cases are identified (lines 35-49).

The I-cache and I-TLB are accessed for each instruction in the window past the long-latency load (line 36). The instruction is marked meaning that the I-cache/TLB access (a potential I-cache/TLB miss) is hidden by the long-latency load—this is done through the I_overlapped variable. This means that the I-cache/TLB access has occurred and should not incur any additional penalty when it appears at the window head (line 12). In other words, the I-cache/TLB access/miss is hidden underneath the long-latency load.

The same procedure is followed for branches and loads if the branch/load is independent of the long-latency load (see lines 38-41 and 43-45, respectively). Independence means that there are no direct or indirect dependences (through registers or memory) between the branch/load and the long-latency load, and there appears no memory barrier between the two loads in the dynamic instruction stream. A branch or load that depends on a long-latency load serializes with the long-latency load and therefore does not get executed underneath the long-latency load.

In case one reaches a serializing instruction while scanning the window upon a long-latency load, one breaks out of the loop and stops scanning the window (line 47). The serializing instruction causes the window to be drained.

An important component in interval simulation is to estimate the critical path length in the old window. The critical path length is used for computing (i) the branch resolution time, (ii) the window drain time upon a serializing instruction, and (iii) the effective dispatch rate. For computing the critical path length, one considers a data flow model that computes the earliest possible issue time for each instruction in the old window given its dependences and execution latency. This is done as follows. For each instruction in the old window, the simulator keeps track of its execution latency (including the L1 D-cache miss latency), its issue time, and its output dependences, i.e., the register(s) that it writes or the cache line that it writes in case of a store. For each instruction that is inserted at the old window tail, the issue time is computed as the maximum issue time of the instructions that it depends upon plus the instruction's execution time. One also keeps track of the old window's ‘head time’ and ‘tail time’. The new tail time is computed as the maximum of the previous tail time and the issue time of the newly inserted instruction; similarly, the new head time is the maximum of the previous head time and the issue time of the removed instruction. One then approximates the length of the critical path in the old window as the tail time minus the head time. This is an approximation of the real critical path in the old window. However, computing the real critical path would require walking the old window for every newly inserted instruction, which is time-consuming and which is why we use the above approximation. The approximation was found to be accurate as demonstrated in the experiments described further below.

Once the critical path length is computed, one can compute the maximum possible execution rate through the old window. Using Little's Law, one computes the execution rate as window size divided by the critical path length. This reflects the fact that the out-of-order processor cannot process instructions faster than dictated by the critical path length. The effective dispatch rate then equals the minimum of this execution rate and the designed dispatch width. The branch resolution time is computed as the longest chain of dependent instructions (including their execution latencies) leading to the mispredicted branch, starting from the head pointer in the old window. The window drain time is computed as the maximum of (i) the number of instructions in the old window divided by the processor's dispatch width, and (ii) the length of the critical execution path in the old window.

Interval length (the number of instructions between two subsequent miss events) has a significant impact on overall performance. In particular for a mispredicted branch, a short interval implies a short dependence path to the branch (i.e., short branch resolution time); a long interval on the other hand implies a longer branch resolution time. A similar effect occurs for serializing instructions: a serializing instruction causes the instruction window to be drained. Window drain time is correlated with the interval length prior to the serializing instruction, i.e., the completely filled window takes longer to drain than a partially filled window. In order to model the dependence of interval length on the branch resolution time and window drain time, the old window is emptied upon a miss event (see lines 16, 26, 30 and 58).

According to one embodiment of the present invention, the simulation methods as described above are combined with simulation whereby mapping is performed to Field Programmable Gate-Arrays (FPGAs). The cycle-accurate timing models typically used in techniques using mapping to FPGA techniques known to persons skilled in the art can, according to an embodiment of the present invention, be replaced by analytical timing models as described above. This does not only speedup FPGA-based simulation, it also shortens FPGA-model development time and in addition it would also enable simulating larger computer systems on a single FPGA.

According to one embodiment of the present invention, the simulation methods as described above are combined with sampled simulation. The latter reduces the number of instructions that need to be simulated and therefore may result in an overall further reduction of the simulation time required. According to some of these embodiments, the simulation based on analytical models including a time simulator replaces the part of the sampled simulation that, according to prior art, use cycle-accurate timing models. According to some alternative embodiments sampled simulation is performed whereby one part is performed using functional simulation with time simulator and another part is performed using cycle-accurate timing models. Thus in alternative embodiments functional simulation between sampling units could be done following the present invention, and the sampling units are simulated through cycle-accurate simulation. This would provide timing estimates between sampling units which would increase accuracy, especially when simulating multicore processors or multiprocessors running multi-threaded workloads.

According to one embodiment of the present invention, the simulation methods as described above according to embodiments of the present invention are combined with statistical simulation. In other words, also for the simulation based on analytical models including a time simulator, the number of instructions to be simulated could be reduced, based on statistical simulation according to prior art.

It is to be noticed that whereas different aspects are described with reference to particular embodiments, such aspects can be combined with each other for one and the same embodiment, embodiments of the present invention not being limited thereto.

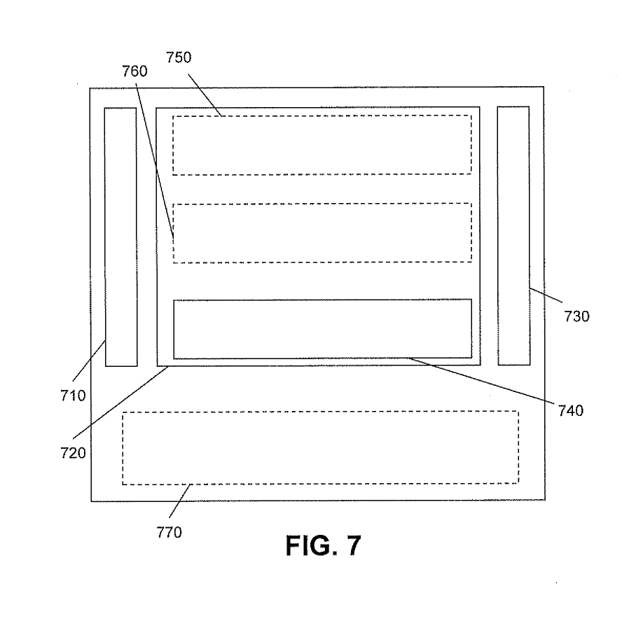

In a second aspect, the present invention relates to a simulator, also referred to as simulation system, for performing a simulation of the processing of a set of instructions by a processor. Such a simulator typically may be computer implemented. The simulator according to embodiments of the present invention typically may comprise an input means for receiving a set of instructions and for receiving a processor architecture or design describing the processor. The simulator according to embodiments of the present invention also comprises a functional simulator for performing a functional simulation of the processor architecture or design with an analytical model comprising a timing estimator. In some embodiments, such a functional simulation component may comprise a miss event predictor, an interval determinator for determining intervals using miss events as borders and a timing estimator for estimating a timing through analysis of at least one of the intervals. An example of such a simulator is shown in FIG. 7. The simulator 700 shows an input means or input channel 710, a functional simulator 720 and an output channel 730. The functional simulator 720 is equipped with a timing estimator 740 based on an analytical model. In advantageous embodiments, the functional simulator 720 comprises a miss event predictor 750, an interval determinator 760, whereby the timing estimator 740 is adapted for determining timing information in the interval. Further optional features and components may also be incorporated in the simulator as will be known by the person skilled in the art. For example, initial input, intermediate results and/or output results may be stored, e.g. temporarily, in a memory 770. Also features and components having the functionality as expressed in any of the steps of the method for simulating the processor as described in the first aspect may be included in the simulator 700. The simulator may in one embodiment be a software system. In another embodiment, the simulator may be a hardware computer system, some components being implemented by software or as particular hardware components.

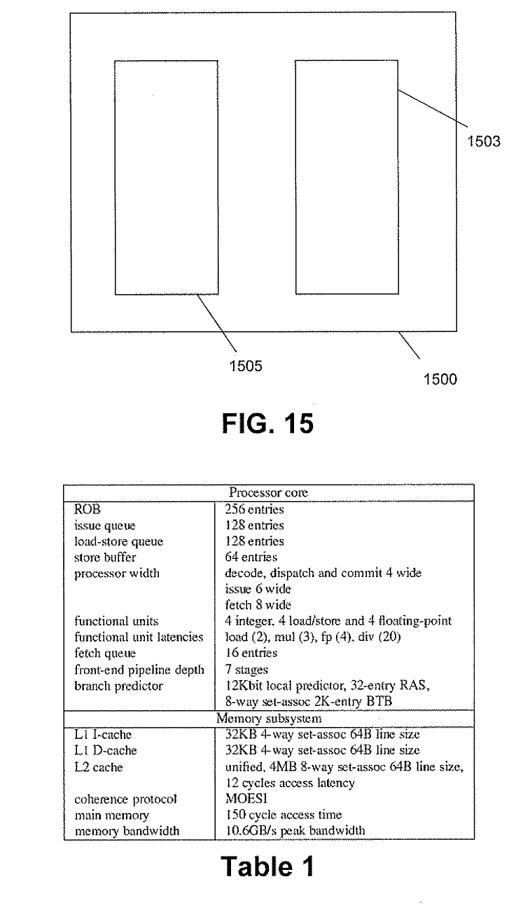

The above described system embodiments for simulating the execution of a set of instructions on a processor may correspond with an implementation of the method embodiments for simulating the execution of a set of instructions on a processor as a computer implemented invention in a processor 1500 such as shown in FIG. 15. FIG. 15 shows one configuration of a processor 1500 that includes at least one programmable computing component 1503 coupled to a memory subsystem 1505 that includes at least one form of memory, e.g., RAM, ROM, and so forth. It is to be noted that the computing component 1503 or computing components may be a general purpose, or a special purpose computing component, and may be for inclusion in a device, e.g., a chip that has other components that perform other functions. Thus, one or more aspects of the present invention can be implemented in digital electronic circuitry, or in computer hardware, firmware, software, or in combinations of them. For example, each of the simulation steps may be a computer implemented step. Thus, while a processor 1500 such as shown in FIG. 15 is prior art, a system that includes the instructions to implement aspects of the methods for simulating execution of processing of a set of instructions is not prior art, and therefore FIG. 15 is not labelled as prior art. The present invention thus also includes a computer program product which provides the functionality of any of the methods according to the present invention when executed on a computing device.

By way of illustration, embodiments of the present invention not being limited thereto, some experimental results are discussed below and a comparison is made between experimental results obtained with a simulator according to an embodiment of the present invention and a detailed cycle-level simulation for the M5 multi-core simulator, known by the person skilled in the art. The comparison has been performed using two benchmark suites, namely SPEC CPU2000 and PARSEC. All of the SPEC CPU2000 benchmarks are used with the reference inputs in our experimental setup. The binaries of the CPU2000 benchmarks were taken from the SimpleScalar website. These binaries were compiled for Alpha using aggressive compiler optimizations. 100 million simulation points as determined by SimPoint were considered in all experiments in order to limit overall cycle-accurate simulation time. In addition to the single-threaded user-level SPEC CPU benchmarks, also the multi-threaded PARSEC benchmarks were used which spend a substantial fraction of their execution time in system code. 9 of the 13 PARSEC benchmarks that run on our simulator were used with the small input set and run each benchmark to completion. The number of dynamically executed instructions per benchmark varies between 500 million to 13 billion instructions. The PARSEC benchmarks were compiled using the GNU C compiler for Alpha. Aggressive optimization was performed, including -O3, loop unrolling and software prefetching. The simulator used in all experiments was the University of Michigan M5 simulator. M5 was previously validated against real Compaq Alpha machines. The SPEC CPU benchmarks are run in user-level simulation mode, and the PARSEC benchmarks are run in full-system simulation mode (running Linux 2.6.8.1).

The baseline core microarchitecture is a 4-wide superscalar out-of-order core, specifications thereof are shown in Table 1. When simulating a multi-core processor, it is assumed that all cores share the L2 cache as well as the off-chip bandwidth for accessing main memory. Furthermore a MOESI cache coherence protocol is assumed. Simulations for up to 8 cores were run, the experimental results being limited thereto due to physical memory constraints.

By way of evaluation, simulation according to an embodiment of the present invention was performed in terms of accuracy and simulation speed. Accuracy is evaluated through a number of experiments: single-threaded workloads, multi-program workloads, multi-threaded workloads, and a performance trend case study are performed.

In a first experiment, single-threaded workloads running on a single-core processor were considered and evaluation of the interval simulation in a step-by-step manner was performed in order to understand where the error sources occurred. For doing so, following experiments are considered; each experiment evaluated a particular aspect of interval simulation:
Effective dispatch rate: the branch predictor was considered to be perfect (i.e., all branch predictions are correct), as well as the I-cache/TLB and L2 cache (i.e., all cache accesses are hits). The L1 D-cache is non-perfect. This setup aims at evaluating the accuracy of the modeling of the effective dispatch rate.
I-cache/TLB: The branch predictor is assumed to be perfect as well as the L1 and L2 D-cache and D-TLB. The I-cache and I-TLB are non-perfect.
Branch prediction: All caches are assumed to be perfect. The only non-perfect structure is the branch predictor.
L2 cache: The L1 I-cache is assumed to be perfect as well as the branch predictor. The L1 D-cache and L2 cache are non-perfect.

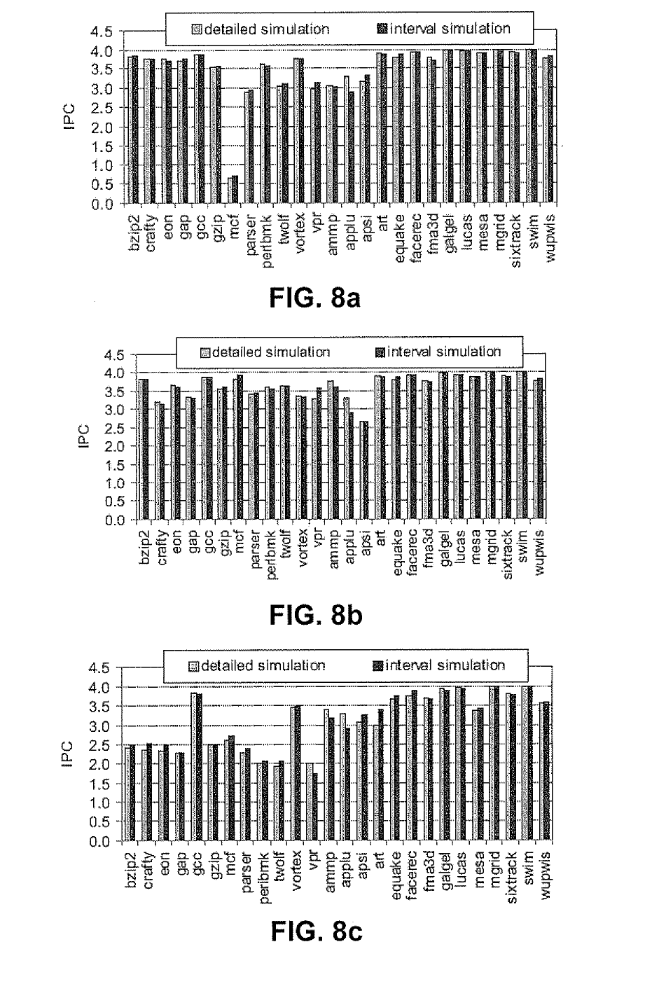

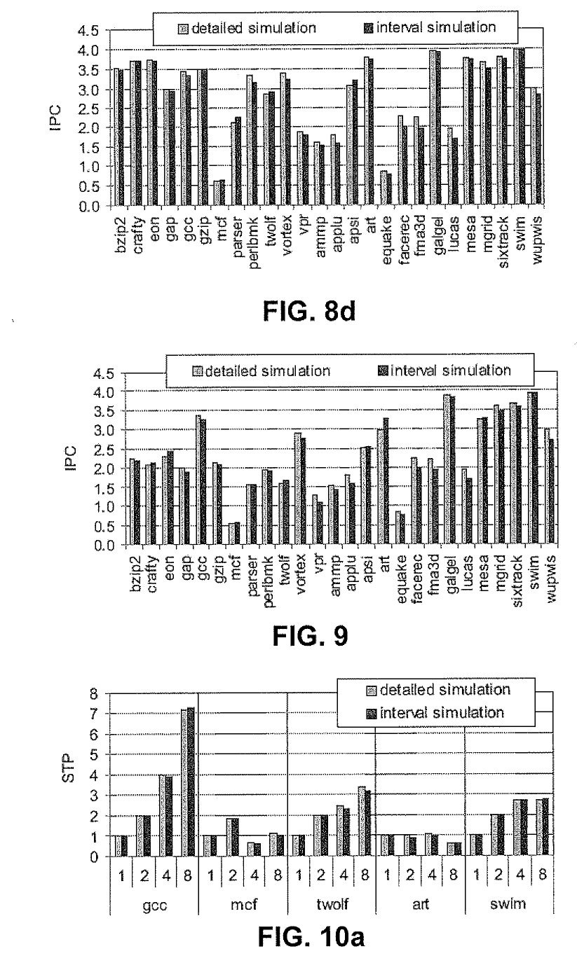

FIG. 8 compares the IPC measured through detailed simulation versus the IPC estimated through interval simulation for each of the above four experiments. FIGS. 8(a) and (b) shows that the effective dispatch rate and I-cache/TLB behavior is modeled accurately: the average error for both experiments is 1.8%. One observes slightly higher errors for the branch prediction and L2 cache modeling with average errors of 3.8% and 4.6%, respectively, see FIGS. 8(c) and (d). The difficulty in predicting the impact of branch mispredictions on performance is due to estimating the branch resolution time. The branch resolution time is the number of cycles between the mispredicted branch being dispatched and the branch being resolved. Interval simulation however approximates the branch resolution time by the critical path leading to the mispredicted branch in the old window. This is an overestimation of the penalty if the critical path is partially executed by the time the mispredicted branch enters the instruction window, or is an underestimation if the critical path execution gets slowed down because of resource contention. With respect to estimating the performance impact of L2 cache misses, interval simulation tends to overestimate the penalty due to L2 misses. Interval simulation basically assumes there are no instructions dispatched underneath the L2 miss, however, the processor may be dispatching instructions while the L2 miss is being resolved. Putting everything together, the average error for the single-threaded benchmarks equals 5.9%, as can be seen in FIG. 9. The maximum error was bounded to 15.5%. The largest errors were due to estimating the branch prediction penalty (vpr, applu, art), and the L2 cache/TLBmiss penalty (equake, facerec, fma3d and lucas).

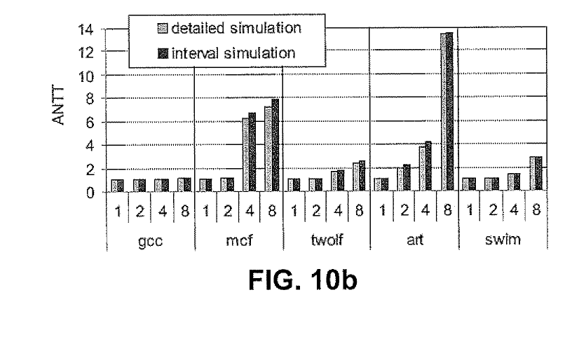

In a second experiment, multi-program workloads were considered, i.e., multiple single-threaded workloads co-execute on a multi-core processor in which each core executes one single-threaded workload. A large set of both homogeneous and heterogeneous multi-program workloads were evaluated, part thereof being reported in FIG. 10. The multi-program workloads that are reported are homogeneous workloads—multiple copies of the same benchmark run concurrently—generated from mcf, art, twolf, gcc and swim, and represent a diverse and interesting subset. System throughput (STP) is reported, being a system-oriented performance metric, and average normalized job turnaround time (ANTT), being a user-oriented performance metric. These metrics are known from prior art. The average error observed across all homogeneous and heterogeneous workloads equals 3.8% and 4.2% for STP and ANTT, respectively; the maximum error is 16% (ANTT for art). The important observation from FIG. 10 is that interval simulation tracks performance trends very accurately. For example, it is observed that STP improves with 2 copies of mcf, however, for 4 and 8 copies, STP decreases and ANTT increases substantially due to L2 cache sharing. A similar trend is observed for art and 8 copies. Also, system throughput improves as the number of copies for gcc is increased, while ANTT is not affected significantly. For twolf on the other hand, ANTT increases as the number of copies is increased. These graphs show that interval simulation is capable of modeling conflict behavior in shared caches accurately.

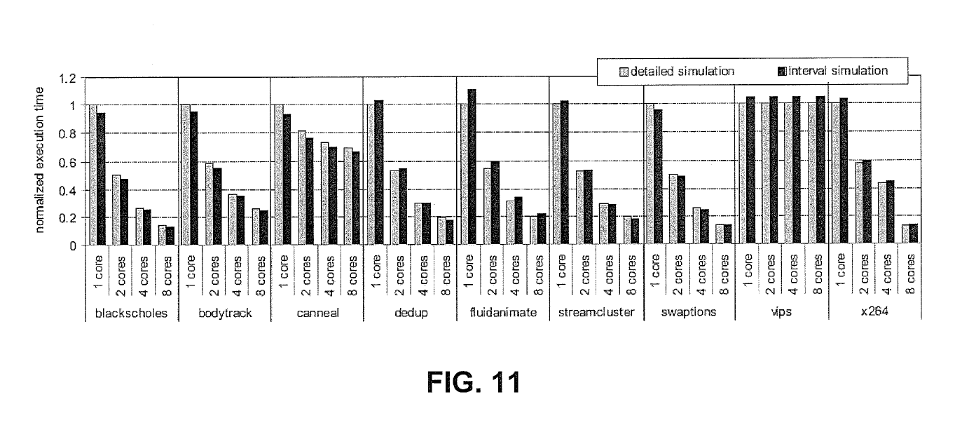

In a following example, the multi-threaded PARSEC benchmarks are considered. These benchmarks incur inter-thread synchronization and cache coherence effects, and were run in full-system mode, i.e., the performance results include OS code. FIG. 11 shows normalized execution time as a function of the number of cores that the multi-threaded workload runs on. The average error when comparing the estimated execution time obtained through interval simulation versus cycle-accurate simulation is 4.6%: the error is below 6% for most benchmarks, except for fluidanimate (11%). It can be seen that interval analysis estimates the performance trend with the number of cores accurately. For example for yips, interval simulation accurately tracks that performance did not improve with an increasing number of cores. The fact that performance did not scale with the number of cores is due to load imbalance and poor synchronization behavior. For the other benchmarks, performance improved with an increasing number of cores. Interval simulation tracks this trend accurately, in spite of the absolute error, even for fluidanimate.

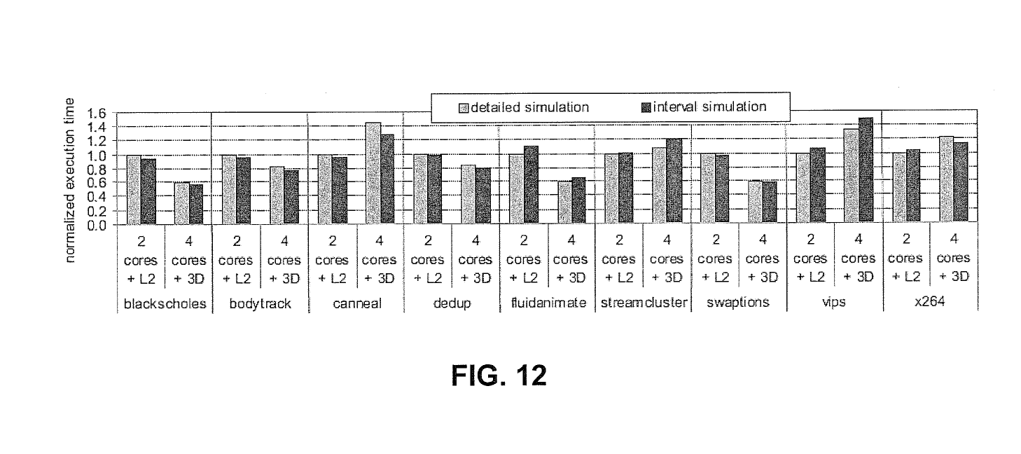

In a further example, a case study is discussed to illustrate the applicability of interval simulation in a practical research study. The case study considers a performance trade-off as a result of 3D stacking, and compares two processor architectures. The first processor architecture is a dual-core processor with a 4 MB L2 cache that is connected to external DRAM through a 16-byte wide memory bus. The second processor architecture is a quad-core processor that is connected to 3D stacked DRAM through a 128-byte memory bus and which does not have an L2 cache. External DRAM is assumed to have a 150-cycle access latency; 3D-stacked DRAM is assumed to have a 125-cycle access latency. It can be seen from FIG. 12 that interval simulation leads to the same conclusions as detailed cycle-accurate simulation. The quad-core processor leads to better performance for a number of benchmarks, such as bodytrack, fluidanimate and swaptions. These benchmarks benefit from increased compute power and/or memory bandwidth. For other benchmarks on the other hand, cache space is more important than processing power and memory bandwidth, and hence, the dual-core processor outperforms the quadcore processor, see canneal, yips and x264. This case study illustrates that interval simulation leads to the same conclusions in practical high-level microarchitecture design trade-offs.

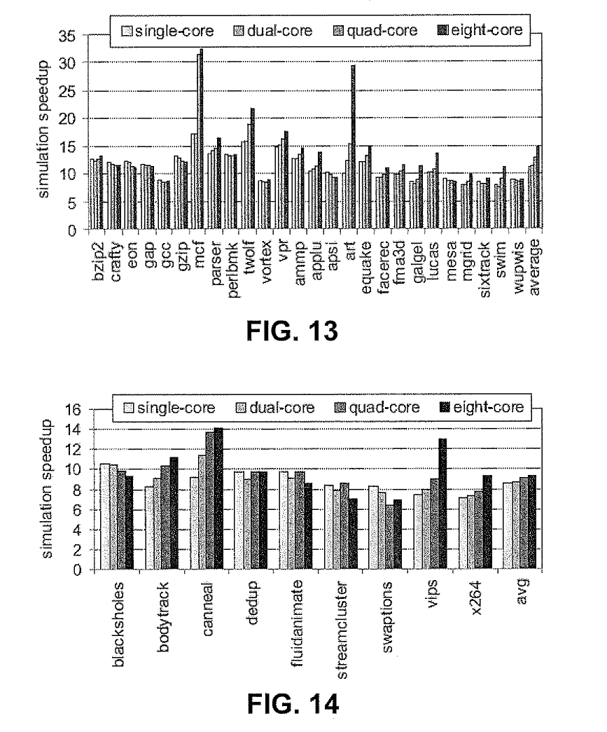

In still a further example simulation speed is studied. Interval simulation is substantially faster than detailed cycle-level simulation, as can be seen in FIG. 13 and FIG. 14, which show the simulation speedup through interval simulation compared to detailed simulation for the multi-program workloads and multi-threaded workloads, respectively. The simulation speedup is a factor 8 to 9 for the multi-threaded workloads, and up to 15× for the multi-program workloads.

In conclusion, in terms of simulation speed, a one order of magnitude improvement compared to detailed simulation is attained. The error with respect to detailed simulation is 5.9% on average for the single-threaded SPEC CPU2000 benchmarks (max error of 16%); for the multi-threaded fullsystem PARSEC benchmarks, the average error is 4.6% across single-, dual-, quad- and eight-core processor configurations (max error of 11%). In addition, it is demonstrated that interval simulation yields similar performance trends and design decisions in practical research studies when trading off the number of processor cores versus cache space versus memory bandwidth. Its high accuracy, fast simulation speed and ease-of-use make interval simulation a useful complement to the architect's toolbox for exploring system-level and high-level micro-architecture trade-offs.

In another aspect, the present invention relates to a data carrier for carrying a computer program product for simulating the processing of a set of instructions by a processor. Such a data carrier may comprise a computer program product tangibly embodied thereon and may carry machine-readable code for execution by a programmable processor. The present invention thus relates to a carrier medium carrying a computer program product that, when executed on computing means, provides instructions for executing any of the methods as described above. The term “carrier medium” refers to any medium that participates in providing instructions to a processor for execution. Such a medium may take many forms, including but not limited to, non-volatile media, and transmission media. Non-volatile media includes, for example, optical or magnetic disks, such as a storage device which is part of mass storage. Common forms of computer readable media include, a CD-ROM, a DVD, a flexible disk or floppy disk, a tape, a memory chip or cartridge or any other medium from which a computer can read. Various forms of computer readable media may be involved in carrying one or more sequences of one or more instructions to a processor for execution. The computer program product can also be transmitted via a carrier wave in a network, such as a LAN, a WAN or the Internet. Transmission media can take the form of acoustic or light waves, such as those generated during radio wave and infrared data communications. Transmission media include coaxial cables, copper wire and fibre optics, including the wires that comprise a bus within a computer.

1. A method for simulating a set of instructions to be executed on a processor, the method comprising performing a functional simulation of the processor over a number of simulation cycles, wherein performing the functional simulation of the processor comprises using an analytical model comprising a timing estimator and estimating during the functional simulation timing information of the processor.

2. A method according to claim 1, wherein using an analytical model comprises using a mechanistic analytical model comprising a timing estimator.

3. A method according to claim 1, wherein estimating timing information comprises deriving a number of instructions performed during a cycle.

4. A method according to claim 1, wherein estimating timing information comprises deriving instantaneous timing information.

5. A method according to claim 1, wherein performing the functional simulation comprises simulating occurrences of miss events and dividing the processing time for the processor in a plurality of intervals based on the simulated miss events.

6. A method according to claim 5, wherein performing the functional simulation comprises estimating timing for at least one of the obtained plurality of intervals, the estimate being based on the simulated miss events.

7. A method according to claim 5, wherein estimating timing comprises determining a timing estimate being based on the simulated miss event terminating the interval under consideration.

8. A method according to claim 1, wherein the functional simulator is adapted for first generating a dynamic instruction stream which is thereafter fed into the timing simulator.

9. A method according to claim 1, wherein estimating timing information comprises estimating timing information for a multi-core processor.

10. A method according to claim 9, wherein the method comprises simulating a particular core for a multi-core processor on an event-driven basis.

11. A method according to claim 6, wherein estimating timing information for at least one of the obtained plurality of intervals comprises adding a penalty to the timing estimate as function of the simulated miss event in the interval.

12. A method according to claim 7, wherein adding a penalty to the timing estimate as function of the simulated miss event in the interval comprises adding a miss latency in case of an I-cache miss or an I-TLB miss, adding a branch penalty in cas of a branch misprediction or adding a penalty for emptying an old instruction window in case of serializing instructions.

13. A method according to claim 12, wherein estimating timing for at least one of the obtained plurality of intervals comprises not adding a penalty if a miss event is independent of and is hidden by a long-latency load.

14. A method according to claim 1, wherein the method comprises estimating a critical path length for executing an instruction in a window of instructions, the critical path length being determined as function of a difference in characteristic time for instructions in the window, the characteristic time being determined by the execution latency, the issue time and the output dependencies for the instruction.

15. A method according to claim 14, wherein the method comprises determining an effective dispatch rate for instructions in the system based on the critical path length.

16. A method according to claim 15, the method comprising, after said functional simulating, adjusting a processor design used for simulating the processing and performing the functional simulation using the adjusted processor design.

17. A simulator for simulating the processing of a set of instructions to be executed on a processor, the simulator comprising a functional simulator for performing a functional simulation of the processor over a number of simulation cycles, wherein the functional simulator of the processor is adapted for using a analytical model comprising a timing estimator adapted for estimating during the functional simulation timing information of the processor.

18. A simulator according to claim 17, wherein the simulator is a computer program product for, when executing on a computer, performing a simulation of the processing of a set of instructions to be executed on a processor.

19. A data carrier comprising a set of instructions for, when executed on a computer, performing a functional simulation of processing of a set of instructions to be executed on a processor over a number of simulation cycles, wherein performing the functional simulation of the processor comprises using an analytical model comprising a timing estimator and estimating during the functional simulation timing information of the processor.

20. A data carrier according to claim 19, wherein the data carrier is any of a CD-ROM, a DVD, a flexible disk or floppy disk, a tape, a memory chip, a processor or a computer.
